(19) United States
(12) Patent Application Publication
(10) Pub. No.: US 2024/0260591 A1
(43) Pub. Date: Aug. 8, 2024

(54) Rolled Dough Product and Method of Producing

(71) Applicant: General Mills, Inc., Minneapolis, MN (US)

(72) Inventors: Cassee Malia Cain, Eden Prairie, MN (US); Christine O'Connor, Rogers, MN (US); Sorin Stingaciu, Richmond Hill (CA)

(73) Assignee: General Mills, Inc., Minneapolis, MN (US)

(21) Appl. No.: 18/568,051

(22) PCT Filed: Jun. 22, 2021
(86) PCT No.: PCT/US2021/038363

§ 371 Date: Dec. 7, 2023

(51) Int. Cl. A21D 13/17; A21D 8/02; A21D 13/19; A21D 13/28

(52) U.S. Cl. CPC A21D 13/17; A21D 8/02; A21D 13/19; A21D 13/28

(57) ABSTRACT

Rolled dough products, such as croissants, are made by: layering fat between thin layers of dough in forming a multi-layer dough sheet; compressing the multi-layer dough sheet; cutting the dough sheet; reorientating the cut pieces; stretching the cut pieces; curling the pieces; flattening the pieces; coating or surface treating the pieces; and optionally freezing the pieces. With this method, freezer-to-oven (FTO) dough products are made eliminating the thawing and proofing steps, while significantly enhancing the production of desired flaky, rich, airy final pastry products. The process can include one or more filling materials, prior to cutting the dough sheet: depositing a filling layer, such as a chocolate ganache, in a central region of the multi-layer dough sheet; and folding lateral side portions of the dough sheet onto the central region to encase the filling layer.

### BACKGROUND OF THE INVENTION

The present invention pertains to rolled food products and, more particularly, to producing laminated rolled dough products, such as puff pastry, croissants, or danish.

A variety of laminated dough products (i.e., rolls) are known in the art. Croissant rolls represent a popular option. When producing rolls on a commercial scale, a dough sheet from which the rolls are formed by the process of folding butter or solid fat into dough multiple times to create very thin alternating layers of fat and dough. Puff pastry is the simplest form with just folded butter and basic dough. Croissant formulation have added yeast and make a richer dough, while danish dough products are the richest and contain the most amount of butter in the dough. By way of a known croissant roll example, the dough sheet may have 16, 24, 36, 48, 96 or even 144 layers. After being laminated, the dough sheet is cut into triangular shaped pieces, with each piece being individually curled to establish a crescent roll shape which can be immediately baked or frozen for future baking.

It is also known to incorporate a filling into a croissant or danish roll. In according to one known prior art arrangement, the filling material is added between the steps of cutting the dough sheet into triangular shaped pieces and rolling the pieces into the individual croissant rolls, resulting in the filling only being present in the very center of the final baked product. In another known prior art arrangement, the filling can be added as a layer prior to the dough sheet being rolled, and the dough even folded over to establish a couple alternating layers of dough and filling.

Although known mass production processes for producing both filled and non-filled croissant or danish rolls are considered satisfactory, these processes can certainly be improved. In particular, it would be desirable to enhance uniformity between the produced products, such as by avoiding excessive flaking or shredding issues widely prevalent in the industry. In addition, it would be beneficial to enhance the ability to distribute any employed filler material throughout the final product. Furthermore, in connection with known filled croissant roll production systems, bursting of the products during cooking is a known issue which, other than by significantly reducing the amount of filler employed, has yet to be resolved.

### SUMMARY OF THE INVENTION

In commercially producing laminated food products, including filled or non-filled or croissants or danish rolls, a dough sheet formed of numerous layers of dough is transported in a first direction with a conveyor system and cut into individual, geometrically-shaped pieces, preferably triangular-shaped pieces. Particularly in accordance with the invention, each triangular-shaped piece is then re-oriented and directed through a compression roller unit which stretches the triangular-shaped piece. After this stretching operation, each stretched triangular-shaped piece is-curled with rolling of each piece starting from a base of the respective triangular-shaped piece to form a crescent shaped product. The curled product is then again compressed prior to receiving a surface treatment wherein exposed portions of the curled compressed product are sprayed or otherwise provided with a coating which functions to prevent premature moisture loss at the surface of the curled compressed product during subsequent baking. More specifically, the coating enables the rolled product to retain moisture longer at the surface during baking to prevent shredding of the surface. The most preferred form of the invention has the curled compressed products frozen after being coated and later baked from a frozen state. Making the freezer-to-oven (FTO) dough products, i.e., the croissants or danish roll, in accordance with the invention has been found to eliminate the thawing and proofing steps and significantly enhance proper product production of desired flaky, rich, airy final pastry products.

As indicated above, the additional compressing and coating steps are performed in accordance with the invention in making both filled and non-filled laminated products. When making filled laminated products, filling material can be added before and/or after the cutting step. In accordance with the pre-cutting addition of a filling in accordance with a preferred embodiment of the invention, a filling layer is continuously deposited in a central region of the dough sheet traveling on the conveyor system. After the filling layer is deposited, lateral side portions of the dough sheet are folded onto the central region, preferably in an overlapping fashion, to substantially encapsulate or encase the filling layer and establish a folded, intermediate product. The folded, intermediate product is then directed through one or more roller units which press the filling layer and the now encapsulating outer layer of the intermediate product. During this process, due to the airy nature of the layered, sheeted dough, the filling layer is at least partially pressed or integrated into the sheeted dough. This intermediate product is then cut into the individual, geometrically-shaped pieces, stretched, curled, compressed and coated as discussed above. When the final baked product is produced, the filling material is visually apparent and distributed throughout the product. More specifically, when the filled, rolled products are baked, the layered dough expands. With this expansion, the filling layer becomes prominently, visually exposed, establishing spiraling, spaced stripe portions on the final product. Although the filling material can take various forms, a color variation between the filling and the baked dough is desired. In a preferred embodiment, a chocolate ganache is employed as the filling layer, with the ganache having a viscosity enabling the filling to be extruded or otherwise spread onto the central portion of the dough sheet while not being free-flowing but a semi solid, thereby remaining in the central portion. Of course, other fillings with similar flow and spread characteristics can also be employed. In any case, in accordance with this embodiment of the invention, the baked product will advantageously have filling available in every bite and the product will provide a clear visual cue of the inside filling.

Additional objects, features and advantages of the invention will become more readily apparent from the following detailed description of preferred embodiments thereof when taken in conjunction with the drawings wherein like reference numerals refer to common parts in the several views.

### BRIEF DESCRIPTION OF THE DRAWINGS

FIG. 1 is a schematic view of initial stages of a production assembly used to produce rolled food products in accordance with the present invention;

FIG. 2 is a schematic view of latter stages of the production assembly used to produce rolled food products in accordance with the present invention;

FIG. 3 shows a pre-baked, rolled product, particularly a crescent roll, formed in accordance with the invention;

FIG. 4 shows the rolled product of FIG. 3 after being baked; and

FIG. 5 shows a variation of the initial production assembly stages of FIG. 1.

### DETAILED DESCRIPTION OF THE INVENTION

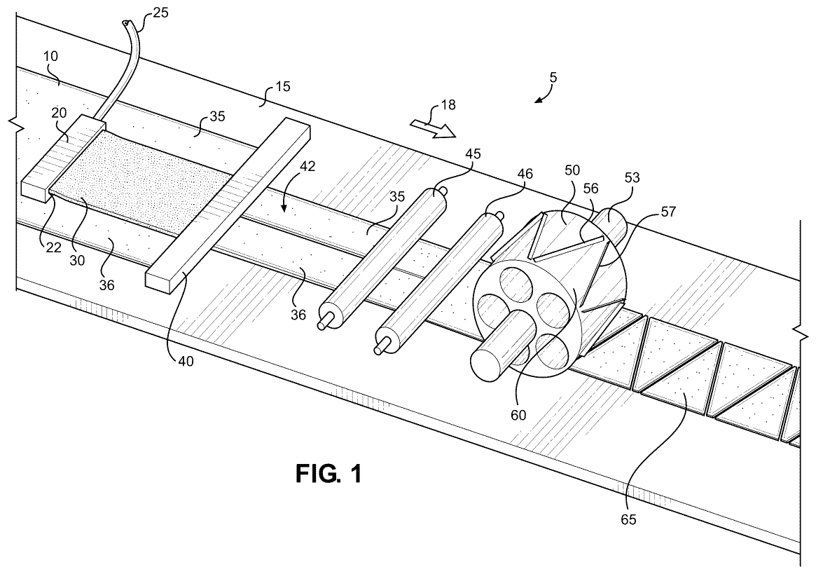

As discussed above, puff pastry, croissants, or the like laminated dough products produced in accordance with the invention can be created with or without filling material. As producing a filled laminated dough product is most comprehensive, reference will initially be made to FIG. 1 in describing the production of a laminated dough product with one or more fillings for purposes of fully understanding of both method and product aspects the invention. As will become fully apparent below, certain described steps are not employed when the rolled dough product being produced does not include any filler material.

As shown, FIG. 1 provides a schematic overview of an exemplary production assembly 5 used to produce croissant rolls in accordance with the present invention. In particular, FIG. 1 shows a dough sheet 10 being transported by a conveyor 15 in a direction 15. Dough sheet 10 is produced in a manner known in the art, except the number of layers is halved from a desired final product. That is, as discussed above, the dough sheet is formed from various layers, with each layer being either a dough layer or, in certain instances, a fat layer. By way of example, a typical dough sheet employed for the production of croissant rolls may have 16,24, 36,48, or 96 layers which enable very flaky and airy final products to be produced. Utilizing this example, dough sheet 10 of the invention would actually have twenty-four layers for the reason which will become fully apparent below.

As illustrated, dough sheet 10 travels upon conveyor 15 to a dispensing station and, more specifically, beneath a filling extruder 20 having an elongated extrusion port 22 and a filling supply tube 25. Here, a filling 30 is dispensed upon dough sheet 10. More specifically, the dispensing of filling 30 is contained to a central portion (not separately labeled) of dough sheet 10, thereby leaving side portions 35 and 36 of dough sheet 10 without any filling material thereon. Filling 30 is particularly configured to have a viscosity which prevents the filling 30 from flowing from the central portion into either of side portions 35 or 36. In addition, although the filling material can take various forms, a color variation between filling 30 and dough sheet 10 is desired for reasons detailed below. In a preferred embodiment, a chocolate ganache is employed as the filling layer, with the ganache having a viscosity enabling filling 30 to be extruded or otherwise spread onto the central portion of dough sheet 10 while not being free-flowing, thereby remaining in the central portion. In this example, the viscosity of the ganache is controlled with the addition of polysaccharides such as starch, and/or sweetening carbohydrates such as granulated sugar or another type of dairy solid material nonfat dried milk or cocoa powder. Basically, the viscosity is established such that filling 30 is not too hard so it cannot be readily dispensed or mechanically spread, yet not too soft so as to be runny or self-spreading. Certainly, a wide range of fillings with similar flow and spread characteristics can also be employed.

After receiving filling 30, dough sheet 10 proceeds to a folding station represented by a folding mechanism generally indicated at 40. Here side portions 35 and 36 are folded upon filling 30, preferably in a slightly overlapping fashion, to establish a folded, intermediate product 42. In this manner, filling 30 is essentially enclosed or encased within dough sheet 10. In addition, with the folding of side portions 35 and 36, the number of dough layers in folded, intermediate product 42 has doubled (more in the overlapped region). Therefore, a forty-eight dough layer containing folded, intermediate product 42 (including at least one additional filling layer) is established starting with a twenty-four layer dough sheet 10.

Next, folded, intermediate product 42 is delivered to and acted on by one or more rollers 45, 46. In one preferred embodiment, folded, intermediate product 42 essentially constitutes an approximately 20 mm dough sandwich that is pressed or sheeted by rollers 45 and 46 to about 5-6 mm sandwich product while keeping filling 30 fully contained. During this process, due to the airy nature of the layered, sheeted dough, filling 39 is at least partially pressed or integrated into the material of dough sheet 10.

After being folded and pressed, intermediate product 42 is delivered to a cutter 50, shown to take the form of a wheel which is mounted upon an axle 53 and includes a plurality of angled cutters or blades, two of which are shown at 56 and 57, spaced by triangular shaped regions 60. With this construction, cutter 50 is configured to continuously cut intermediate product 42 into a series of triangular-shaped pieces 65.

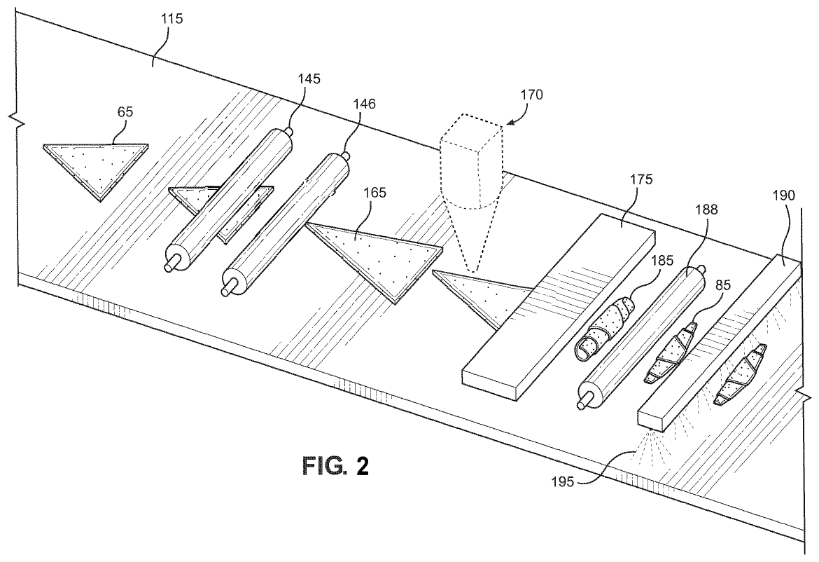

Initially, it was believed that triangular-shaped pieces 65 could, at this point in the process, be curled and frozen for subsequent baking. Instead, it was found that an unacceptable product was produced if the thawing and proofing steps were not completed from freezer to oven. In fact, a majority of the baked pieces would literally break open on the top of the dough product from internal pressure upon baking. However, it was later realized that the inclusion of various additional steps in the process, at least some of which have been found to be critical, enables consistent production of the desired product. Surprisingly, it has been found that the same additional steps synergistically combine to not only avoid the bursting issues when a filling material is employed, but also solve surface breaking open and/or shredding and product consistency issues previously observed with both filled and non-filled rolled product production. Therefore, in accordance with the invention, with reference to FIG. 2, each triangular-shaped piece 65 is rotated by a rotating unit (not shown) in a reorientation stage and then directed onto a faster moving conveyor 115 which functions to space out successive triangular-shaped pieces 65 in a direction of travel. Thereafter, each triangular-shaped piece 65 goes through a compression stage by being sent through a pressing or compressing unit, shown in the form of one or more rollers 145 and 146, to form a stretched triangular-shaped piece 165. In accordance with a preferred form of the invention, stretching stage expands the length of triangular-shaped piece 65 at least 50% and, more preferably, in the range of 50%-100% and, most preferably about 75% in forming the stretched triangular-shaped piece 165. Although this stretching stage could be performed before the cutting stage, the stretching is more accurately and uniformly performed on individual triangular-shaped pieces 165.

At this point, it should be noted that, prior to rolling or curling each stretched triangular-shaped piece 165, an optional, additional center filling can be added. If an initial or additional filling is desired at this stage, the same can be provided by a dispenser or depositor 170. If an additional filling, the filling material can, but need not be, the same material as filling 30. In certain preferred embodiments, the additional filling is distinct, such as being constituted by cinnamon, raspberry, a pastry cream, cream cheese, or various other known pastry fillings, including jams or jellies.

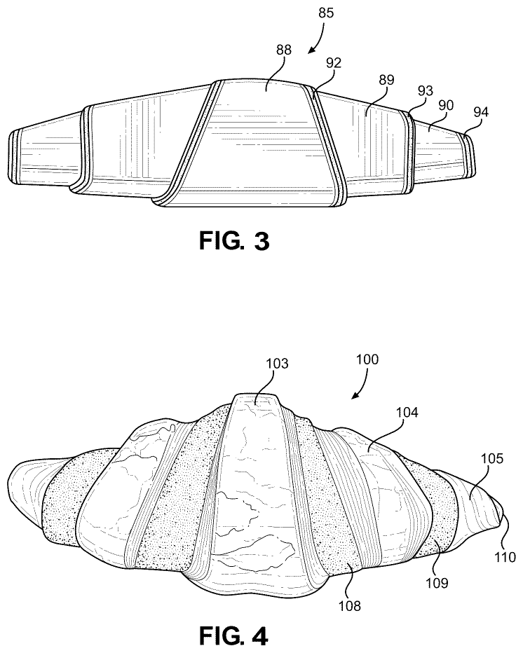

More generically for producing filled or non-filled rolled products, the next stage in the process is curling each stretched triangular-shaped piece 165. Like the other stages discussed above, this stage can be performed manually or, more preferably for mass production, continuously through the use of a rolling machine (generically indicated at 175), starting from a base of each triangular-shaped piece 165, to form a curled product 185. Thereafter, rolled product is compressed, such as through one or more rollers 188 operating at a speed between 105-140 RPMs, to form a pressed or flattened, curled, laminated product 85. In the most preferred embodiment in making croissants or danish rolls (preferably in the order of 30-108 grams in weight), curled product 185 is compressed to about 10-22 mm in forming compressed, curled, laminated product 85. Most preferably, this compression operation results in compressed, curled laminated product 85 not deviating side-to-side any more than approximately 2 mm. As shown in more detail in FIG. 3 in connection with an embodiment including filler 30, compressed, curled, laminated product 85 includes multiple outer body regions (including outer body regions 88, 89 and 90) each having multiple dough layers spaced by a respective exposed filling layer (including exposed filling layers or regions 92, 93 and 94). Here, again in the connection with the original filler embodiment, the filling 30 in filling regions 92-94 is readily visible and, as indicated above, is preferably of a different color than outer body regions 88-90.

Referring back to FIG. 2, the compressed, curled, laminated products 85 are still further processed in accordance with the invention by surface treating each compressed, curled, laminated product 85. More specifically, as shown, each compressed, curled, laminated product 85 is directed through a surface treatment unit 190 whereupon exposed portions of the compressed, curled, laminated product 85 are sprayed (shown), brushed, dipped or otherwise provided with a coating material 195. Basically, the coating functions as a barrier functioning to prevent premature moisture loss at the surface of the rolled product during subsequent baking. More specifically, during baking, the surface of the compressed, curled, laminated product 85 rises well above 212° F. before expansion of the dough is complete which, albeit for the coating barrier, were found to result in excess shredding of the surface. In accordance with the invention, the treated surface retains moisture longer during the baking process. Although various coating formulations are potentially possible, the most preferred form of the invention employs a coating constituted by a formulation of water, egg yolk or whole eggs and a hydrocolloid blend, with the hydrocolloid blend preferably including a hydrocolloid, a gum and a starch. Certain preferred formulations were created by mixing about 33-50% water, egg yolk or whole eggs, and 2-10% hydrocolloid blend under high shear at 150-300 RPM and 200 RPM being preferred for 30 seconds. Although various carbohydrates, polysaccharides maltodextrins, water soluble crystalline substances sugar and sugar alcohols, were considered for use, a preferred blend of polysaccharides and hydrocolloids.

After the surface treatment stage, products 85 could be baked, but are preferably freezer-to-oven (FTO) products and are therefore frozen and packaged for later baking. In either case, a baked product produced in accordance with the invention is shown in FIG. 4 (again the filled rolled product version) wherein it can be recognized that the laminated, curled, compressed and coated product 85 has expanded in becoming a flaky, rich and airy baked product 100 having toasted outer regions 103-105 with, at most, minimal shredding and baked volume comparable to a thaw and proofed offering. The invention has shown that a proofing step can be eliminated, particularly found with the combination of dough with a 1.90 or greater F/W ratio, compressing the curled product to not less than 10 mm thick while exhibiting a flush surface that does not significantly deviate from side to side. Still, with this type of dough formulation and compression, excessive shredding could occur during the baking process, but the added surface treatment removes this issue, such that the combination of steps synergistically combine to advantageously result in baked product 100. In connection with this filled product version, it is also clear from this figure that expanded filling regions 108-110 advantageously provide a clear visual cue of the filling, with the exposed portions of products 85 being protected by the coating material and bursting of product 85 is avoided.

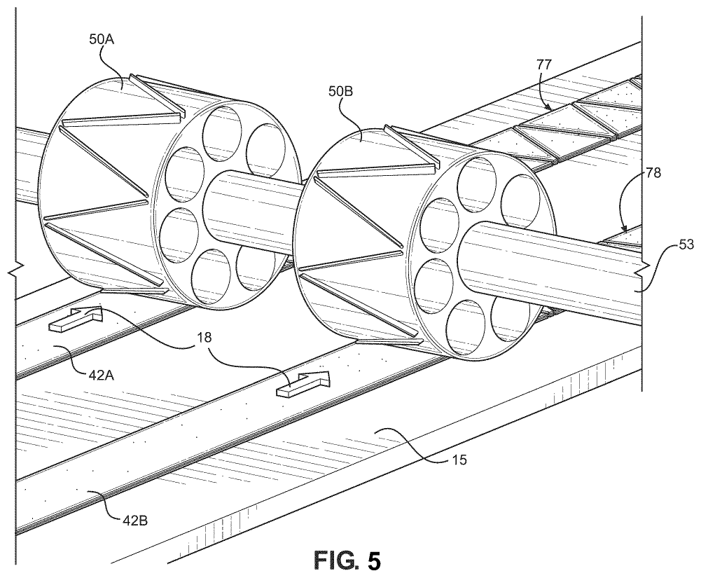

Based on the above, it should be readily apparent that the present invention provides for producing rolled dough products which avoids bursting and/or shredding problems prevalent in the art. In embodiments employing a filling, the filling is integrated into the dough thereby, among other advantages, making filling dispersed substantially evenly throughout the resulting baked product so as to be available for every bite. Importantly, the pre-stretching, compressing and surface treatment stages have been found to provide a synergistic effect in the consistent product production of desired flaky, light, airy final pastry products. Although certain preferred embodiments of the present invention have been set forth, it should be understood that various changes or modifications could be made without departing from the present invention. It should certainly be recognized that the above-described stages could be performed manually but, more preferably, are part of a commercial mass production process. By way of example, if mass produced, more than one product line can be established using conveyor 15. This is at least represented in FIG. 5 for early stages of process wherein multiple dough sheets 42A and 42B are directed upon conveyor 15 beneath adjacent cutters 50A and 50B which are mounted on common axle 53 for producing intermediate product lines 77 and 78.

1. A method of producing laminated dough products, the method comprising:
cutting a laminated dough sheet to form individual pieces;
stretching the individual pieces;
curling the individual pieces to establish curled pieces;
compressing the curled pieces to form compressed, curled pieces; and
surface treating the compressed, curled pieces such that exposed surface portions of each compressed, curled piece are coated.

2. The method of claim 1 wherein, after cutting to form the individual pieces and before curling the individual pieces, re-orientating the individual pieces.

3. The method of claim 1, wherein the individual pieces are stretched from 50% to 100%.

4. (canceled)

5. The method of claim 1, wherein the curled pieces are pressed so as to be flattened to a range 10-22 mm in forming the compressed, curled pieces.

6. The method of claim 1, wherein the surface treating includes applying a formulation of water, a hydrocolloid and/or polysaccharide blend, and egg yolk or whole eggs.

7. (canceled)

8. The method of claim 1, further comprising, prior to cutting the dough sheet:
dispensing a filling upon a central region, located between side portions, of the dough sheet; and
folding the side portions of the dough sheet over the filling to encase the filling in forming a folded, intermediate dough product.

9. The method of claim 8, further comprising dispensing the filling by extruding the filling across only the central region of the dough sheet, wherein the filling has a viscosity which avoids the filling from running into the side portions of the dough sheet.

10. (canceled)

11. The method of claim 8, further comprising press rolling the folded, intermediate dough product prior to cutting.

12. The method of claim 11, wherein the folded, intermediate dough product is press rolled to about 5-6 mm.

13. The method of claim 11, wherein the dough sheet has multiple layers and the filling is integrated into the multiple layers upon press rolling the folded, intermediate dough product, each rolled piece has multiple outer body regions, and each outer body region has multiple dough layers spaced by a respective exposed filling layer.

14. The method of claim 8, further comprising dispensing an additional filling onto each of the individual pieces after stretching the individual pieces and prior to curling, wherein the additional filling is constituted by cinnamon, raspberry, a pastry cream, cream cheese, jam or jelly.

15. (canceled)

16. The method of claim 1, wherein the compressed, curled pieces are croissants or danish rolls.

17. The method of claim 16, further comprising:
freezing the compressed, curled pieces to create frozen and compressed pieces.

18. A laminated dough product comprising:
a rolled body including a plurality of spaced, flattened outer body regions; and
a coating provided on the outer body regions.

19. The laminated dough product of claim 18, wherein the rolled body is flattened to about 10-22 mm.

20. The laminated dough product of claim 19, wherein a thickness of the laminated dough product does not deviate any more than approximately 2 mm across an entire rolled body of the laminated dough product.

21. The laminated dough product of claim 19, wherein the laminated dough product is a frozen croissant or danish roll.

22. The laminated dough product of claim 18, wherein the coating is constituted by a formulation of water, egg yolk or whole eggs and a polysaccharide and/or hydrocolloid blend.

23. (canceled)

24. The laminated dough product of claim 18, further comprising: a plurality of exposed filling regions spaced between respective ones of the outer body regions, wherein each outer body region has multiple layers spaced by a respective one of said plurality of exposed filling regions and the plurality of exposed filling regions are established by spiraling, spaced stripe portions on the laminated dough product.

25. (canceled)

26. The laminated dough product of claim 24, wherein the plurality of exposed filling regions are darker in color than the plurality of spaced outer body regions.

27. (canceled)
